(19) United States
(12) Patent Application Publication
(10) Pub. No.: US 2008/0086221 A1
(43) Pub. Date: Apr. 10, 2008

(54) MACHINE-TOOL CONTROLLER

(75) Inventor: Tetsuo OGAWA, Yamatokoriyama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MORI SEIKI CO., LTD., Yamatokoriyama-shi (JP)

(21) Appl. No.: 11/870,048

(22) Filed: Oct. 10, 2007

(30) Foreign Application Priority Data
Oct. 10, 2006 (JP) 2006-276469

(51) Int. Cl. G05B 11/01

(52) U.S. Cl. 700/17

(57) ABSTRACT

Machine-tool controller (1) has a screen display processor (19), and a movement-status recognition processor (18) that defines for modeled structural elements interference-risk regions obtained by displacing outwards the structural elements' outer geometry, then generates data modeling post-movement moving bodies to check whether the they would intrude into any interference-risk region, and if so, transmits to the screen display processor (19) the locations where, and a signal indicating into which interference-risk region, the intrusion would occur. Based on the generated modeling data, the screen display processor (19) generates, and has a screen display device (43) display onscreen, image data in accordance with the modeling data, generating the image data in such a way that it is displayed at a display magnification in accordance with the interference-risk region into which intrusion would occur, with the intrusion locations being in the midportion of the screen display device (43).

### TECHNICAL FIELD

In machine tools furnished with one or more moving bodies, with a feed mechanism for driving the moving body to move them, with a structural element placed in the region in which the moving body travels, and with a screen display means for displaying image data, the present invention relates to machine-tool controllers that in accordance with movements of the moving body generate image data of the moving body and the structural element, and onscreen display the image data on the screen display means.

### DESCRIPTION OF THE RELATED ART

Such machine-tool controllers known to data include the example disclosed in Japanese Unexamined Pat. App. Pub. No. H05-19837. This machine-tool controller is set up in a lathe provided with, for example, first and second main spindles for holding workpieces, first and second tool rests for holding tools, a feed mechanism for moving the first and second tool rests in predetermined feed directions, and a display for displaying image data of the workpieces and tools onscreen.

In a situation in which, for example, a workpiece in the first main spindle is machined with a tool in the first tool rest, and a workpiece in the second main spindle is machined by a tool in the second tool rest, the machine-tool controller splits the onscreen display area of the display into two display zones to display on one of the two display zones the workpiece in the first main spindle and the tool in the first tool rest, and on the other, the workpiece in the second main spindle and the tool in the second tool rest.

Therein, in displaying the tools on the display screen, the controller recognizes operational commands for the tools (tool rests) from a machining program, and generates image data showing the situation in which the tools have been moved into move-to points involving the recognized operational commands, and onscreen displays the image data in the respective display zones. Furthermore, this implementation is configured to display the workpieces continuously in the midportions of the display zones, in an immobilized state, and, due to limitations of the onscreen display area of the display, to display the tools onscreen only when present within prescribed regions in the proximity of the workpieces.

A machine-tool operator views the display screen to check on the tool operations, whereby the positional relationships between the tools and the workpieces, the status of tool movement, and the status of the machining of the workpieces by the tools can be verified, to check whether the tools and workpieces will interfere with each other.

Patent Document 1: Japanese Unexamined Pat. App. Pub. No. H05-19837.

A problem with the conventional controllers described above, however, has been that with the workpieces being displayed in the midportions of the onscreen-presentation zones of the display and the tools being displayed surrounding the workpieces, the tools are not displayed in the midportions of the onscreen-presentation zones, which has been prohibitive of verifying the positional relationships between the tools and the workpieces, the status of tool movement, and other operational conditions. Further, approaches that have the operator perform display-range and display-magnification settings and other operations that would facilitate such verification lead to the problem of the troublesomeness of the setting operation, and the problem of having to alter the display-range and display-magnification suitably in accordance with operational conditions such as the positional relationship between the tools and the workpieces.

### BRIEF SUMMARY OF THE INVENTION

An object of the present invention, brought about taking into consideration the circumstances described above, is to make available a machine-tool controller that enables an operator to readily comprehend the operational status of, such as the positional relationships between, the moving bodies and structural elements.

To achieve this object, a machine-tool controller according to a preferred aspect of the present invention is a controller provided in a machine tool including at least one moving body, a feed mechanism that drives the moving body so as to move, at least one structural element placed within a region in which the moving body can travel, and a screen display means that displays image data, the machine-tool controller comprising: a control execution processing unit that controls, based on an operational command for the moving body, actuation of the feed mechanism to control at least a move-to point of the moving body; a modeling data storage in which modeling data relating to two-dimensional or three-dimensional models of, and including geometry data defining shapes of, the moving body and structural element, is stored; and a screen display processor that generates two-dimensional or three-dimensional image data of the moving body and structural element to allow the screen display means to display the image data onscreen; a display magnification data storage that stores display magnifications that are scales at which the image data is displayed, the display magnifications being applied when the moving body and/or structural element enters one or more interference-risk regions formed by offsetting outwards a contour of the moving body and/or structural element, and being defined for each of the interference-risk regions so that their inner sides has larger scale that their outer sides with respect to offset orientation; a movement-status recognition processor that executes a process of defining the one or more interference-risk regions for the two-dimensional or three-dimensional models of the moving body and/or structural element, and of receiving from the control execution processing unit the moving body move-to point to generate, based on the defined interference-risk regions, on the received move-to point, and on the modeling data stored in the modeling data storage, modeling data describing the situation in which the moving body has been moved into the move-to point, a process of checking from the generated modeling data whether or not the moving body and/or structural element will intrude into the interference-risk regions, and a process of, when the entrance into the interference-risk regions is determined, recognizing which interference-risk region the moving body and/or structural element will enter, and where is the point at which the moving body and/or structural element will enter the recognized interference-risk region, and of sending to the screen display processor an intrusion-determination signal showing that the moving body and/or structural element will enter the recognized interference-risk region and the recognized intrusion location, and the machine tool controller configured so that the screen display processor executes a process of generating, based on the modeling data, generated by the movement-status recognition processor, and describing the situation in which the moving body has been moved into the move-to point, the image data in accordance with such modeling data to allow the screen display means to display it onscreen, and a process of, when the intrusion-determination signal and intrusion location are received from the movement-status recognition processor, recognizing from the received intrusion-determination signal the interference-risk region the moving body and/or structural element will enter to determine which display magnification stored in the magnification data storage corresponds to the recognized interference-risk region, and of generating, based on the recognized display magnification and on the received intrusion location, the image data to allow the screen display means to display the image data onscreen so as to appear at the display magnification, with the intrusion location coinciding with the center point of the onscreen display area of the screen display means.

With the machine-tool controller according to this aspect of the present invention, the modeling data relating to two-dimensional or three-dimensional models of, and including at least the geometry data defining the shapes of, the moving body and structural element, is previously generated as appropriate, and then stored in the modeling data storage.

It should be understood that examples of the moving bodies and structural elements may include, if the machine tool is a lathe, the bed, the headstock disposed on the bed, the main spindle rotatably supported by the headstock, the chuck that mounted to the main spindle to hold the workpiece, the workpiece, the saddle moveably disposed on the bed, the tool rest disposed on the saddle and holding the tool, the tool, the tailstock moveably disposed on the bed, and the tailstock spindle held in the tailstock. Or, if the machine tool is a machining center, for instance, the bed, the column disposed on the bed, the spindle head moveably supported on the column, the main spindle rotatably supported by the spindle head to hold the tool, the tool, and the table moveably disposed on the bed to hold the workpiece are also examples of the moving bodies and structural elements. Moreover, covers and guards are also typically provided to the machine tool in order to prevent the intrusion of chips and cutting fluid, so these covers and guards are also examples of the moving bodies and structural elements.

The modeling data for all the moving bodies and structural elements making up the machine tool, however, is not necessarily stored, so at least modeling data for those of the moving bodies and structural elements to be displayed on the screen of the screen display means may be stored. Specifically, for example, in a lathe, to display a tool and workpiece onscreen, the modeling data for the tool and workpiece may be stored, and to display onscreen a tool rest, tool, headstock, main spindle, chuck, workpiece, tailstock and tailstock spindle, the modeling data for them may be stored. Moreover, for example, in a machining center, to display a tool and workpiece onscreen, likewise the modeling data for the tool and workpiece may be stored, and to display onscreen a spindle head, main spindle, tool, table and workpiece, the modeling data for them may be stored.

Furthermore, the modeling data may be generated as large as, and may be generated so as to be slightly larger than, the actual moving body and structural element.

Moreover, the display magnifications that are scales at which the image data is displayed onscreen by the screen display processor on the screen display means, and that are applied when the moving body and/or structural element enters one or more interference-risk regions formed by offsetting outwards a contour of the moving body and/or structural element is previously defined as appropriate, and is stored in the display magnification data storage. Such display magnifications have been defined for each of the interference-risk regions so that their inner sides have larger scale than their outer sides with respect to offset orientation.

And, when the moving body is moved with at least the move-to point being controlled as a result of the feed mechanism actuation under the control of the control processing unit, on the basis of the operational commands involving an automatic operation and a manual operation for the moving body, the movement-status recognition processor defines one or more interference-risk regions for the two-dimensional or three-dimensional models of the moving body and/or structural element, and receives from the control execution processing unit the move-to point of the moving body, to generate, based on the defined interference-risk regions, on the received move-to point, and on the modeling data stored in the modeling data storage, the modeling data describing the situation in which the moving body has been moved into the move-to point to check whether or not the movement of the moving body will cause the moving body and/or structural element to intrude into the interference-risk regions. The screen display processor generates, based on the modeling data, generated by the movement-status recognition processor, describing the situation the moving body has been moved, the image data in accordance with the modeling data to allow the screen display means to display the image data onscreen.

It should be understood that whether of not the moving body and/or structural element will intrude into the interference-risk regions is determined from, for example, whether if the moving body modeling data is present in the interference-risk regions for the structural element, or whether or not structural element modeling data is present in those for the moving body.

When it is determined that the moving body and/or structural element will intrude into the interference-risk regions, the movement-status recognition processor recognizes which interference-risk region the moving body and/or structural element will enter and where is the point at which the moving body and/or structural element will enter the recognized interference-risk region, and sends to the screen display processor an intrusion-determination signal showing that the moving body/or structural element will enter the recognized interference-risk region, and the recognized intrusion location.

Furthermore, receiving from the movement-status recognition processor the intrusion-determination signal and intrusion location, the screen display processor recognizes from the received intrusion-determination signal the interference-risk region the moving-body and/or structural element will enter to determine which display magnifications stored in the display magnification data storage corresponds to the recognized interference-risk region, and generates, based on the determined display magnification and on the received intrusion location, image data to allow the screen display means to display it onscreen so as to appear at the display magnification, with the intrusion location coinciding with the center point of the onscreen display area of the screen display means.

For this reason, when the moving body and structural element approach toward each other, and intrude into the interference-risk regions, the part where entrance occurs is enlarged at a predetermined display magnification, and is displayed on the center part of the display screen of the screen display means.

As just described, according to the machine-tool controller involving the present invention, the part where the approach of the moving body and structural element toward each other increases the chance that interference may occur is enlarged and displayed onscreen, so that the operators can grasp simply through the screen display of the screen display means the positional relationship between the moving body and the structural element and the movement of the moving body because the controller is configured so that with one or more interference-risk regions being defined around the moving body and/or structural element, and with the display magnifications in the situation in which the moving body and/or structural element enters the interference-risk regions being defined so as to be larger than those in the situation in which the moving body and/or structural element does not enter the regions, when the moving body and/or structural element enters the interference-risk regions, the part where such an entrance occurs is enlarged at the predetermined scale and displayed in the center part of the display screen of the screen display means.

Furthermore, the display magnifications are defined so the inner sides of the interference-risk regions have a larger scale than the outer sides of them with respect to offset orientation, so that the smaller the distance between the moving body and the structural element, the more largely the part having the increased chance of interference occurrence is displayed, which enables the operators to smoothly grasp such a part.

Moreover, the controller may be configured so that the screen display processor, when receiving from the movement-status recognition processor the intrusion-determination signal and intrusion location, recognizes from the received intrusion-determination signal the interference-risk region the moving body and/or structural element will enter to determine which display magnification stored in the display magnification data storage corresponds to the recognized interference-risk region, and checks from the received intrusion location the number of the entrance-occurring part, and when there is one entrance-occurring part, generates, based on the determined display magnification and on received intrusion location, image data to allow the screen display means to display the image data onscreen so as to appear at the display magnification with the intrusion location coinciding with the center point of the onscreen display area of the screen display means, and on the other hand, when there are a plurality of entrance-occurring parts, checks whether or not all the entrance-occurring parts can be displayed at the display magnification, and when it is determined that all of them can be displayed, generates the image data to allow the screen display means to display the image data onscreen so as to include all the parts and so as to appear at the display magnification, and when it is determined that all of them cannot be displayed, generates the image data to allow the screen display means to display the image data onscreen so as to include all the parts and so as to appear at the maximum display magnification enabling display of all the parts.

In this configuration, when receiving from the movement-status recognition processor the intrusion-determination signal and intrusion location, the screen display processor recognizes from the received intrusion-determination signal the interference-risk region the moving body and/or structural element will enter to determine which display magnification stored in the display magnification data storage corresponds to the recognized interference-risk region, and checks from the intrusion location the number of the entrance-occurring parts. When there is one entrance-occurring part, the screen display processor generates, based on the determined display magnification and on the received intrusion location, image data to allow the screen display means to display it onscreen so as to appear at the display magnification with the intrusion location coinciding with the center point of the onscreen display area of the screen display means.

On the other hand, when there are plurality of entrance-occurring parts, the screen display processor checks from the determined display magnification and received intrusion location whether or not all the parts can be displayed at this display magnification, and when it is determined that all the parts can be displayed, generates the image data to allow the screen display means to display the image data onscreen so as to include all the parts so as to appear at the display magnification, but when it is determined all the parts cannot be displayed, generates the image data to allow the screen display means to display the image data so as to include all the parts, and so as to appear at the maximum display magnification enabling display of all of them.

Also in such a configuration, in the situation in which the moving body and structural element approach toward each other, and intrude into the interference-risk regions, the entrance-occurring part is enlarged at the predetermined display magnification, and is displayed on the center part of the display screen of the screen display means when there is one the entrance-occurring part, and when there are a plurality of entrance-occurring parts, they can be displayed at the predetermined display magnification, or at the maximum scale that enables displaying all of them, so that as described above, the operators smoothly grasps through the screen display of the screen display means the positional relationship between the moving body and the structural element, and the movement of the moving body.

Also a feasible configuration in which the movement-status recognition processor executes, in addition to above processes, a process of checking from the generated modeling data whether or not the moving body and structural element will mutually interfere, and when they are determined to interfere with each other, of recognizing the point at where interference will occur to send to the screen display processor the recognized interference point, and to send an alarm signal to the control execution processing unit, and the screen display processor, when receiving the interference point from the movement-status recognition processor, generates, based on the received interference point, the image data to allow the screen display means to display the image data onscreen so as to appear at a display magnification larger than the maximum display magnification stored in the display magnification data storage, with the interference point coinciding with the center point of the onscreen display area of the screen display means, and the control execution processing unit stops the movement of the moving body when receiving the alarm signal from the movement-status recognition processor.

In this configuration, the movement-status recognition processor further checks from the generated modeling data whether or not the moving body and structural element will mutually interfere. Whether or not the moving bodies and structural elements will mutually interfere is determined based on, for example, whether or not there are portions where the modeling data for the moving bodies contacts or overlaps with the modeling data for the structural elements. If such an overlapping or contacting portion is created between the moving bodies' modeling data and the structural elements' modeling data, it is determined that the moving bodies and structural elements will interfere. Additionally, in a situation in which the moving bodies and structural elements are tools and workpieces respectively, and the modeling data of the tools and that of the workpieces overlap with each other, it is determined that the tools and workpieces will mutually interfere, except when the overlapping portion is created between the blades of the tools and workpieces.

When it is determined from the results of the interference checking that the moving body and structural element will interfere, the interference point is recognized to send the recognized interference point to the screen display processor, and the alarm signal is sent to the control execution processing unit. Receiving the interference point, the screen display processor generates the image data to allow the screen display means to display the image data onscreen so as to appear at the display magnification larger than the maximum display magnification stored in the display magnification data storage with the interference point coinciding with the center point of the onscreen display area of the screen display means. Receiving the alarm signal, the control execution processing unit stops the feed mechanism actuation to halt the movement of the moving body.

As just described, the part where the interference between moving body and the structural element will occur can be widely displayed on the center part of the display screen of the screen display means by generating the image data to allow the screen display means to display the image data onscreen so as to appear at the display magnification larger than the maximum display magnification stored in the display magnification data storage with the received interference point coinciding with the center point of the onscreen display area of the screen display means when the screen display processor receives the interference point. Therefore, the interference point is more quickly identified, and the efficiency of the operators' work is improved.

Also feasible is a configuration in which the controller is further comprises a move-to point predicting unit that receives from the control execution processing unit at least current points of the moving bodies to predict from the received current points the move-to points into which the moving bodies will be moved after a predetermined period of time passes, and the movement-status recognition processor is configured to, in generating modeling data describing the situation in which the moving bodies have been moved, receive from the move-to point predicting unit the predicted move-to points for the moving bodies to generate, based on the received predicted move-to points, and on the modeling data stored in the modeling data storage, the modeling data describing the situation in which the moving bodies have been moved into the predicted move-to points.

In this configuration, based on the move-to point, predicted by the move-to point predicting unit, and into which the moving body will be moved after the predetermined period of time passes, the modeling data describing the situation in which the moving body has been moved is generated, and whether or not the moving body and structural element will mutually interfere and whether or not the moving body and structural element will intrude into the interference-risk regions are checked, and image data is generated to be on screen, based on the generated modeling data, so that before the moving body is actually moved by driving the feed mechanism under the control of the control execution processing unit, whether or not interference will occur is previously checked, and additionally the positional relationship between the moving body and the structural element, the movement of the moving body, can be previously checked. Therefore, interference is reliably prevented from occurring, and, advantageously, various operations can be performed.

Herein, the move-to points can be predicted, for example, from the current point and speed of the moving body, and from current point of the moving body, the operational commands, for the moving bodies, obtained by analyzing the machining program, and the operational commands, for the moving bodies, involving the manual operation.

As just described, according to the machine tool controller involving the present invention, one or more interference-risk regions are defined around the moving body and/or structural element, and when the moving body and structural element enter the regions, the part where such an entrance occurs is enlarged at the predetermined scale, and is displayed on the center part of the display screen of the screen display means, so that the part where the approach of the moving body and structural element toward each other increases the chance that interference may occur is enlarged and displayed onscreen. Therefore, operators smoothly grasp through the displayed image the positional relationship between the moving body and the structural element and the movement of the moving body. Additionally, the smaller the distance between the moving body and the structural element, more widely the part having the higher chance that interference may occur is displayed, which enables the operators to smoothly grasp such a part.

Furthermore, because the controller is configured so that the screen display processor checks the number of the part where the moving body and structural element will intrude into the interference-risk regions, and when there is one entrance-occurring part, the part is enlarged at the predetermined scale, and is displayed on the center part of the display screen of the screen display means, and when there are several entrance-occurring parts, they are enlarged at the predetermined scale, or at the maximum scale enabling display of all the parts, the moving body and structural element can be effectively displayed onscreen even if there are a plurality of entrance-occurring parts, not one entrance-occurring part.

Moreover, the configuration in which the screen display processor generates the image data to allow the screen display means to display it onscreen so as to appear at the display magnification larger than the maximum display magnification stored in the display magnification data storage with the interference point of the moving body and structural element coinciding with the center point of the onscreen display area of the screen display means enables identifying smoothly the interference part. In addition, the configuration in which the interference checking and screen display are carried out based on the predicted move-to point of the moving body enables carrying out the interference checking and the moving body screen display before the moving body actually travels, which are preferable for various operations.

From the following detailed description in conjunction with the accompanying drawings, the foregoing and other objects, features, aspects and advantages of the present invention will become readily apparent to those skilled in the art.

### BRIEF DESCRIPTION OF THE SEVERAL VIEWS OF THE DRAWINGS

FIG. 1 is a schematic block diagram illustrating the constitution of the machine-tool controller in accordance with a first embodiment of the present invention.

FIG. 2 is a schematic front view illustrating the constitution of a numerically-controlled (NC) lathe provided with the machine-tool controller in accordance with this embodiment.

FIG. 3 is an explanatory diagram illustrating the data structural elements of the interference data stored in the interference data storage in accordance with this embodiment.

FIG. 4 is an explanatory diagram illustrating the data constitution of the display magnification stored in the display magnification data storage involving the present invention.

FIG. 5 is a diagram explaining the interference-risk regions involving this embodiment.

FIG. 6 is a flow chart representing a series of the processes in the movement-status recognition processor involving this embodiment.

FIG. 7 a flow chart representing a series of the processes in the movement-status recognition processor involving this embodiment.

FIG. 8 a flow chart representing a series of the processes in the movement-status recognition processor involving this embodiment.

FIG. 9 is a flowchart showing a series of processes performed by the screen display processor in accordance with this embodiment.

FIG. 10 is a flowchart showing a series of processes performed by the screen display processor in accordance with this embodiment.

FIG. 11 is a flowchart showing a series of processes performed by the screen display processor in accordance with this embodiment.

FIG. 12 is a flowchart showing a series of processes performed by the screen display processor in accordance with this embodiment.

FIG. 13 is an explanatory diagram illustrating an example of a display screen displayed on the screen display device by the screen display processor in accordance with this embodiment.

FIG. 14 is an explanatory diagram illustrating an example of a display screen displayed on the screen display device by the screen display processor in accordance with this embodiment.

FIG. 15 is an explanatory diagram illustrating an example of a display screen displayed on the screen display device by the screen display processor in accordance with this embodiment.

FIG. 16 is an explanatory diagram illustrating an example of a display screen displayed on the screen display device by the screen display processor in accordance with this embodiment.

FIG. 17 is an explanatory diagram illustrating an example of a display screen displayed on the screen display device by the screen display processor in accordance with this embodiment.

FIG. 18 is an explanatory diagram illustrating an example of a display screen displayed on the screen display device by the screen display processor in accordance with this embodiment.

FIG. 19 is a diagram explaining the interference-risk regions involving other embodiment.

### DETAILED DESCRIPTION OF THE INVENTION

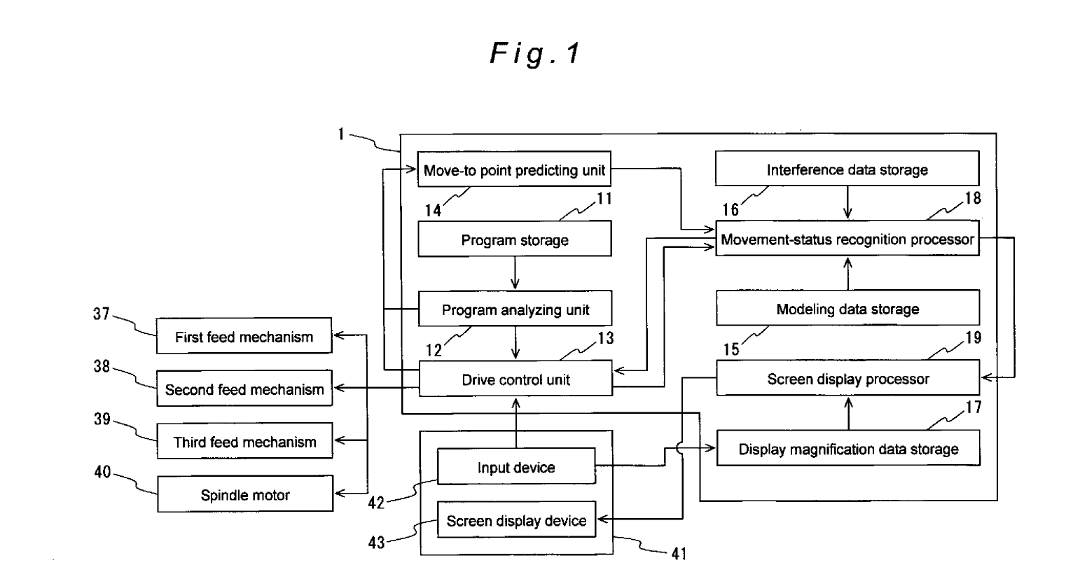

A specific embodiment of the present invention is explained hereinafter with reference to the accompanying drawings. FIG. 1 is a block diagram representing an outlined configuration of a machine tool controller involving a first embodiment of the present invention.

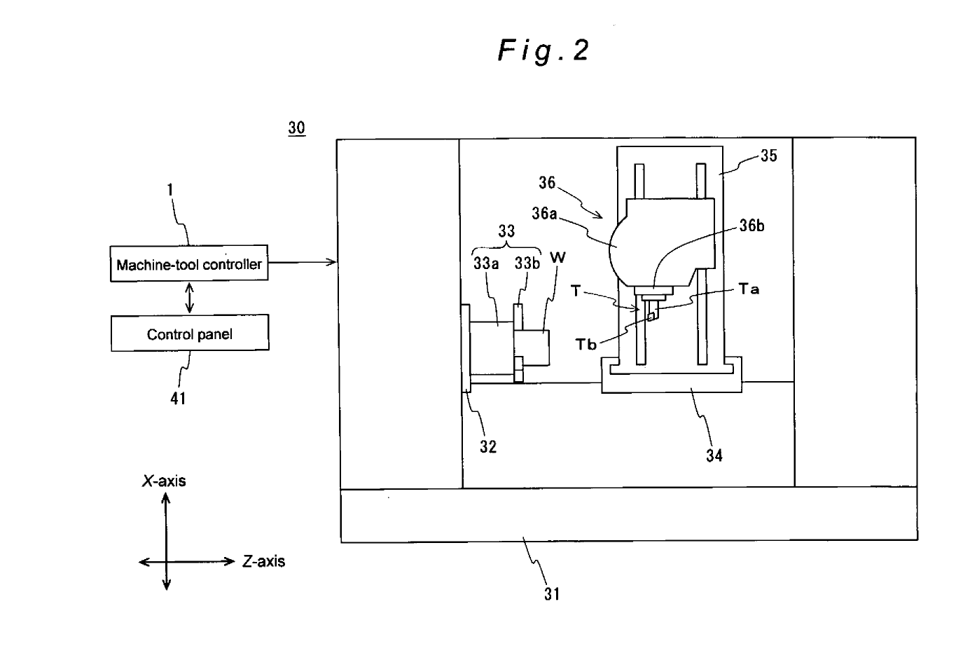

As illustrated in FIG. 1, a machine tool controller 1 (hereinafter, referred to simply as “controller”) of this embodiment is configured with a program storage 11, a program analyzing unit 12, a drive control unit 13, a move-to point predicting unit 14, a modeling data storage 15, an interference data storage 16, a display magnification data storage 17, a movement-status recognition processor 18 and a screen display processor 19. The controller 1 is provided in a NC lathe 30 as illustrated in FIG. 2.

First, the NC lathe 30 will be explained hereinafter. As illustrated in FIG. 1 and FIG. 2, the NC lathe 30 is provided with a bed 31, a (not-illustrated) headstock disposed on the bed 31, a main spindle 32 supported by the (not illustrated) headstock rotatably on the horizontal axis (on Z-axis), a chuck 33 mounted to the main spindle 32, a first saddle 34 disposed on the bed 31 movably along Z-axis, a second saddle 35 disposed on the first saddle 34 movably along the Y-axis perpendicular to Z-axis in a horizontal plane, a tool rest 36 disposed on the second saddle 35 movably along X-axis perpendicular to both Y-axis and Z-axis, a first feed mechanism 37 for moving the first saddle 34 along the Z-axis, a second feed mechanism 38 for moving the second saddle 35 along the Y-axis, a third feed mechanism 39 for moving the tool rest 36 along the X-axis, a spindle motor 40 for rotating the main spindle 32 axially, a control panel 41 connected to the controller 1, and the controller 1 for controlling the actuation of the feed mechanisms 37, 38, 39 and spindle motor 40.

The chuck 33 comprises a chuck body 33a and a plurality of grasping claws 33b that grasp a workpiece W. The tool rest 36 is configured with a tool rest body 36a and a tool spindle 36b that holds a tool T. The tool T, which is cutting tools and other turning tools, is configured with a tool body Ta and a tip (blade) Tb for machining the workpiece W.

The control panel 41 comprises an input device 42, such as an operation keys for inputting various signals to the controller 1 and a manual pulse generator for inputting a pulse signal to the controller 1, and a screen display device 43 for displaying onscreen a state of control by the controller 1.

The operation keys include an operation mode selecting switch for switching operation modes between automatic and manual operations, a feed axis selector switch for selecting feed axes (X-axis, Y-axis and Z-axis), movement buttons for moving the first saddle 34, second saddle 35, and tool rest 36 along a feed axis selected by the feed axis selector switch, a control knob for controlling feedrate override, and setup button for defining a display magnification that will be described hereinafter. The signals from the operation mode selecting switch, feed axis selector switch, movement buttons, control knob, and setup button are sent to the controller 1.

The manual pulse generator is provided with the feed axis selector switch for selecting the feed axes (X-axis, Y-axis and Z-axis), a power selector switch for changing travel distance per one pulse, and a pulse handle that is rotated axially to generate pulse signals corresponding to the amount of the rotation. The operating signals from the feed axis selector switch, power selector switch, and pulse handle are sent to the controller 1.

Next, the controller 1 will be explained. As described above, the controller 1 is provided with the program storage 11, program analyzing unit 12, drive control unit 13, move-to point predicting unit 14, modeling data storage 15, interference data storage 16, display magnification data storage 17, movement-status recognition processor 18, and screen display processor 19. It should be understood that the program storage 11, program analyzing unit 12 and drive control unit 13 function as a control execution processing unit recited in the claims.

In the program storage 11, a previously created NC program is stored. The program analyzing unit 12 analyzes the NC program stored in the program storage 11 successively for each block to extract operational commands relating to the move-to point and feed rate of the tool rest 36 (the first saddle 34 and second saddle 35), and to the rotational speed of the spindle motor 40, and sends the extracted operational commands to the drive control unit 13 and move-to point predicting unit 14.

When the operation mode selecting switch is in automatic operation position, the drive control unit 13 controls, based on the operational commands received from the program analyzing unit 12, rotation of the main spindle 32 and movement of the tool rest 36. Specifically, the rotation of the main spindle 32 is controlled by generating a control signal, based on feedback data on current rotational speed from the spindle motor 40, and based on the operational commands, to send the generated control signal to the spindle motor 40. Additionally, the movement of the tool rest 36 is controlled by generating a control signal, based on feedback data on a current point of the tool rest 36 from the feed mechanism 37, 38, 39, and based on the operational commands, to send the generated control signal to the feed mechanisms 37, 38, 39.

Furthermore, when the operation mode selecting switch is in the manual operation position, the drive control unit 13 generates, based on the operating signal received from the input device 42, operational signals for the feed mechanisms 37, 38, 39 to control their actuations. For example, when the movement button is pushed, the drive control unit 13 recognizes, from a selection made from feed axes by means of the feed axis selector switch, which of the feed mechanisms 37, 38, 39 is to be activated, and recognizes from the control exerted by means of the control knob the adjusted value of the feedrate override, to generate an operational signal including data on the recognized feed mechanisms 37, 38, 39, and on the movement speed in accordance with the recognized adjusted value to control the actuations of the feed mechanisms 37, 38, 39, based on the generated operational signals. Furthermore, when the pulse handle of the manual pulse generator is operated, the drive control unit 13 recognizes from the feed axis selected by means of the feed axis selector switch which of the feed mechanisms 37, 38, 39 is to be activated, and recognizes from the power selected with the power selector switch the amount of travel per one pulse, to generate operational signals including data on that of the feed mechanisms 37, 38, 39 having been recognized, data on the recognized amount of movement per one pulse, and a pulse signal generated by the pulse handle, and performs controlling, based on this operational signals.

The drive control unit 13 stops the actuation of the feed mechanisms 37, 38, 39 and spindle motor 40 when receiving an alarm signal sent from the movement-status recognition processor 18. In addition, the drive control unit 13 sends data involving the tool T to the movement-status recognition processor 18 when the tool T set up in the tool rest 36 is changed to another tool T. Also the drive control unit 13 sends to the move-to point predicting unit 14 the current points and speeds of the first saddle 34, second saddle 35, and tool rest 36, and the generated operational signals.

The move-to point predicting unit 14 receives from the program analyzing unit 12 the operational commands relating to the move-to point and feed rate of the tool rest 36, and receives from the drive control unit 13 the current points, the current speeds, and the operational signals of the first saddle 34, second saddle 35, and tool rest 36, to predict, based on the received operational commands or operational signals and current points, and on the received current points and speeds, the move-to points into which the first saddle 34, second saddle 35, and tool rest 36 are moved after a predetermined period of time passes, and then the move-to point predicting unit 14 sends to the movement-status recognition processor 18 the predicted move-to points, and received operational commands and received operational signals. In the move-to point predicting unit 14, block operational commands on block or more in advance (ahead) of those that are analyzed by the program analyzing unit 12 and executed by the drive control unit 13 are processed in succession.

In the modeling data storage 15, for example, three-dimensional modeling data, previously generated as appropriate, involving at least the tool T, workpiece W, main spindle 32, chuck 33, first saddle 34, second saddle 35, and tool rest 36 is stored. Such three dimensional modeling data is formed with at least geometry data defining three-dimensional shapes of the tool T, workpiece W, main spindle 32, chuck 33, first saddle 34, second saddle 35, and tool rest 36 being included.

It should be understood that the three-dimensional modeling data, which is employed as interference region when interference checking, may be generated as large as, or so as to be slightly larger than, the actual size.

In the interference data storage 16, previously determined interference data defining interference relationships among the tool T, workpiece W, main spindle 32, chuck 33, first saddle 34, second saddle 35, and tool rest 36 is stored.

In the NC lathe 30, the main spindle 32 is held in a (not-illustrated) headstock, with the main spindle 32, chuck 33 and workpiece W being integrated, and the first saddle 34 is disposed on the bed 31, with the first saddle 34, second saddle 35, tool rest 36 and tool T being integrated. Therefore, interference relationships are not established among the main spindle 32, chuck 33 and workpiece W, and among the first saddle 34, second saddle 35, tool rest 36 and tool T. The interference relationships, however, are established only between the main spindle 32, chuck 33 and workpiece W and the first saddle 34, second saddle 35, tool rest 36, and tool T.

Moreover, although the interference among the tool T and workpiece W is regarded as machining of the workpiece W with the tool T (that is, not regarded as interference), it is not regarded as machining, but regarded as interference, except when the interference occurs between the tip Tb of the tool T and the workpiece W.

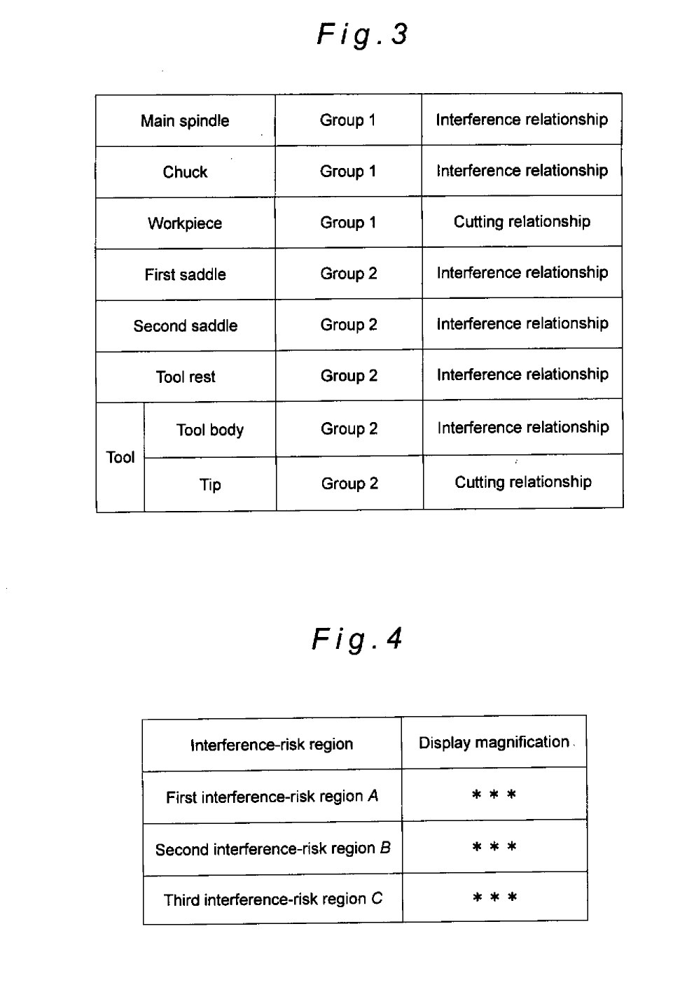

Therefore, specifically, as illustrated in FIG. 3, the interference data is defined as data representing which of the interference relationship and cutting relationship is established among some groups to which the tool T, workpiece W, main spindle 32, chuck 33, first saddle 34, second saddle 35, and tool rest 36 are classified according to what are integrated.

And, according to this interference data, the main spindle 32, chuck 33 and workpiece W are classified to a first group, and the first saddle 34, second saddle 35, tool rest 36 and tool T are classified to a second group. It should be understood that as described above, no interference occurs among items in the same group, but it occurs among items belonging to different groups, and additionally, even if the interference occurs between the items belonging to the different groups, it is not regarded as interference in the situation in which these items establish cutting relationship—that is, the items establishing the interference relationship are tip Tb of the tool T and workpiece W.

As represented in FIG. 4, display magnifications that are scales at which the image data is displayed onscreen by the screen display processor 19 on the screen display device 43, and that are defined for each of the interference-risk regions and applied when the tool T and tool spindle 36b intrude into the interference-risk regions is stored in the display magnification data storage 17. It should be understood that the display magnifications are defined based on an input signal from the setup button of the input device 42, or automatically defined, as appropriate.

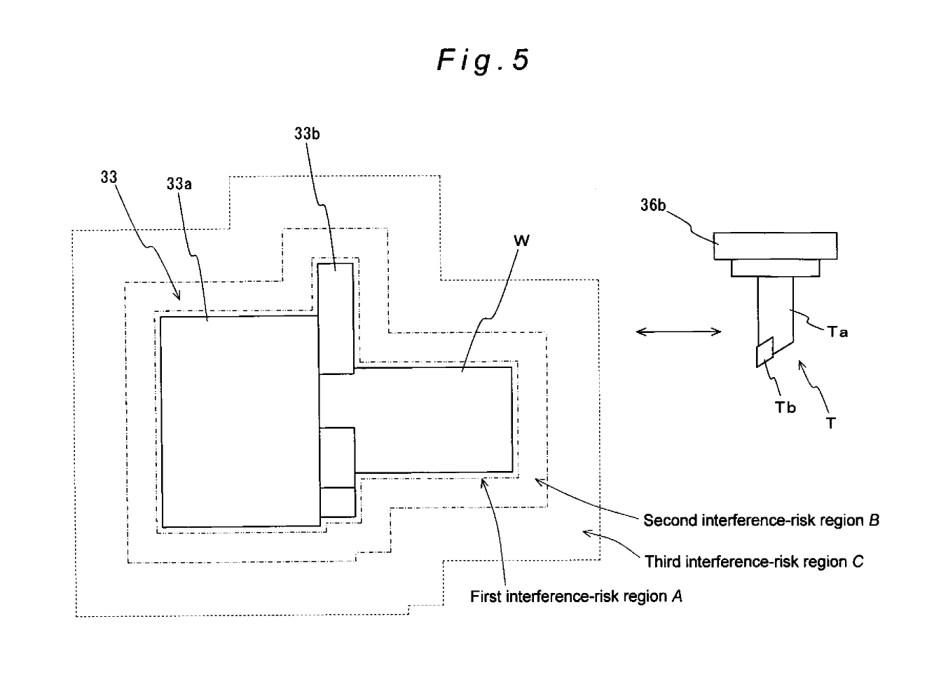

As illustrated in FIG. 5, the interference-risk regions are formed by, for example, offsetting outwards contours of the chuck 33 and workpiece W. In this embodiment, three interference-risk regions (a first interference-risk region A having offset of 1 mm, a second interference-risk region B having offset of 30 mm, and a third interference-risk region C having offset of 80 mm) that have different offsets are defined. It should be understood that the illustrations of the main spindle 32 and tool rest body 36a are omitted from FIG. 5.

The display magnifications are defined so that a scale applied within the first interference-risk region A is larger than that outside the regions A with respect to offset orientation, a scale applied within the second interference-risk region B is larger than that outside the region B with respect to the offset orientation, and a scale applied within the third interference-risk region C is larger than that outside the region C with respect to the offset orientation—that is, the display magnification is increased as the interference-risk regions A, B, C are narrowed. It should be understood that outside the third interference-risk region C, entire image including the chuck 33, workpiece W, toot T and a part of tool spindle 36b is displayed on the screen display device 43, and a display magnification applied outside the third interference-risk region C is defined so as to be smaller than that applied inside the third interference-risk region C.

The movement-status recognition processor 18 receives successively from the move-to point predicting unit 14 the predicted move-to points of the first saddle 34, second saddle 35 and tool rest 36 to check, based on the received predicted move-to points, and on data stored in the modeling data storage 15 and interference data storage 16, whether or not the tool T and tool spindle 36b will intrude into the interference-risk regions A, B, C, and to check whether or not the tool T, workpiece W, main spindle 32, chuck 33, first saddle 34, second saddle 35 and tool rest 36 interfere with each other.

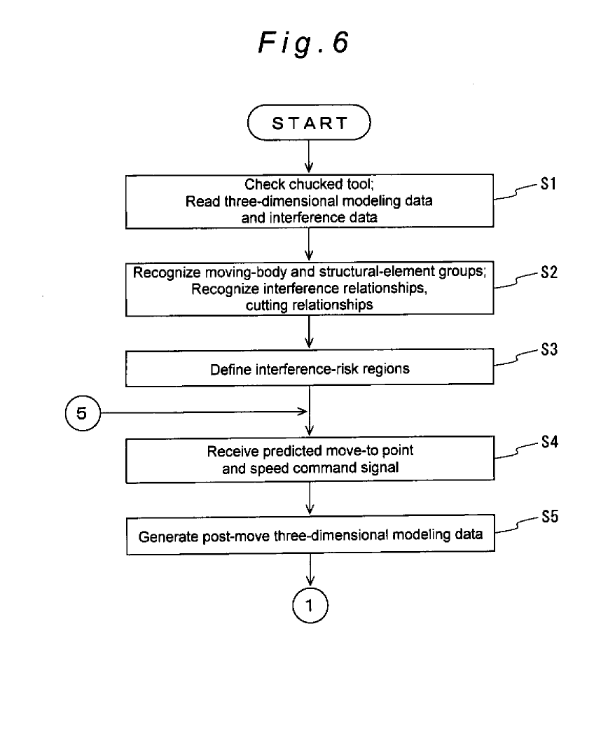

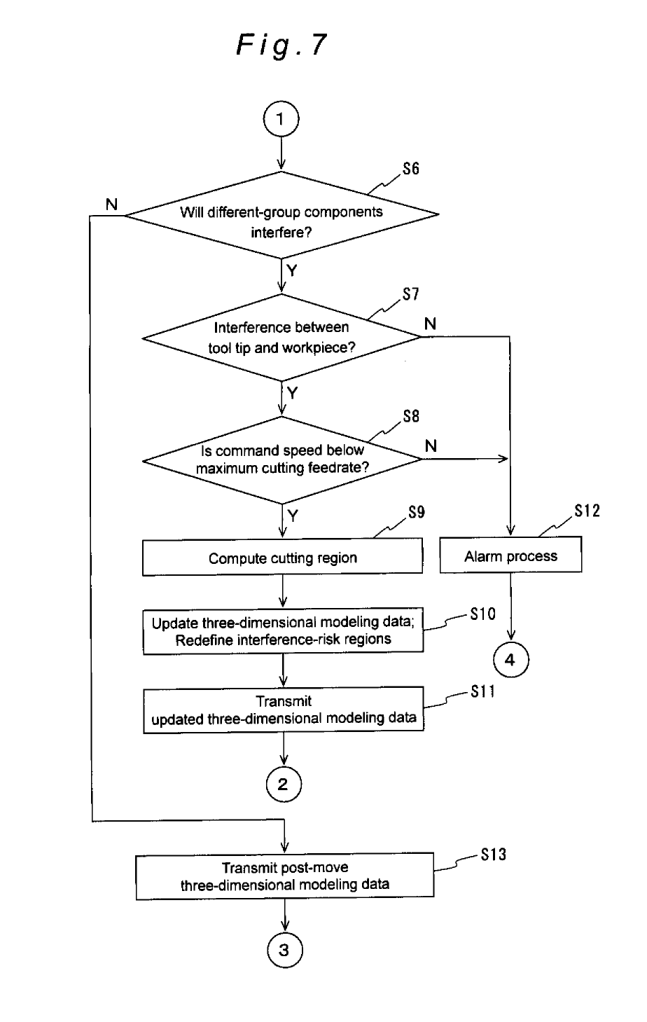

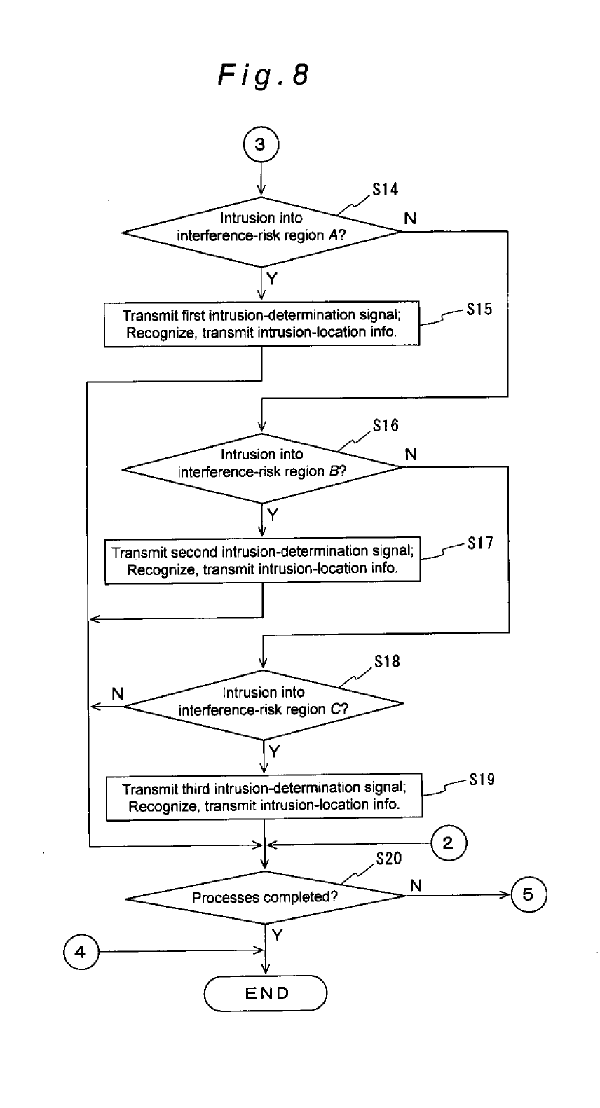

Specifically, the movement-status recognition processor 18 is configured to successively execute a series of processes as represented in FIG. 6 through FIG. 8. Firsts the movement-status recognition processor 18 recognizes the tool T held in the tool rest 36, based on the data, received from the drive control unit 13, on the tool T held in the tool rest, and reads the three-dimensional modeling data, stored in the modeling data storage 15, for the tool T, workpiece W, main spindle 32, chuck 33, first saddle 34, second saddle 35, tool rest 36, and the interference data stored in the interference data storage 16 (Step S1). It should be understood that in reading the three-dimensional modeling data for the tool T, the movement-status recognition processor 18 reads the three-dimensional modeling data for the recognized tool T.

Next, referring to the read interference data, the movement-status recognition processor 18 recognizes to which groups the tool T, workpiece W main spindle 32, chuck 33, first saddle 34, second saddle 35, and tool rest 36 belong, as well as recognize the tool T, workpiece W, main spindle 32, chuck 33, first saddle 34, second saddle 35, and tool rest 36 establish which of the cutting relationship and interference relationship (Step S3).

Subsequently, the movement-status recognition processor 18 receives from the move-to point predicting unit 14 the predicted move-to points of the tool rest 36, and the operational commands and signals (a speed command signal) involving the moving speed (step S4), and generates, based on the defined interference-risk regions A, B, C, on the read three-dimensional modeling data, and on the received predicted move-to points, three-dimensional modeling data describing the situation in which the first saddle 34, second saddle 35, tool rest 36 and tool T have been moved into the predicted move-to points (Step S5).

After that, the movement-status recognition processor 18 checks, based on the read interference data, and on the generated three-dimensional modeling data, whether or not the movements of the first saddle 34, second saddle 35, tool rest 36 and tool T cause interference among the tool T, workpiece W, main spindle 32, chuck 33, first saddle 34, second saddle 35, and tool rest 36—that is, whether or not there is a contacting or overlapping portion in the three-dimensional modeling data for the items belonging to the different groups (among the three-dimensional modeling data for the main spindle 32, chuck 33 and workpiece W belonging to the first group, that of the first saddle 34, second saddle 35, tool rest 36 and tool T belonging to the second group (Step S6).

When it is determined in Step S6 that there is contacting or overlapping portion, the movement-status recognition processor 18 checks whether or not the contacting or overlapping occurs between items establishing a cutting relationship—that is, the contacting or overlapping occurs between the tip Tb of the tool T and the workpiece W (Step 7), and when the contacting or overlapping is determined to do so, the movement-status recognition processor 18 checks whether or not the received command speed is within the maximum cutting feed rate (Step S8).

When the command speed is determined in Step S8 to be within the maximum cutting feed rate, the movement-status recognition processor 18 defines that the contacting or overlapping in the three dimensional modeling data is caused by machining the workpiece W with the tool T, and calculates the overlapping portion (interference (cutting) region) (Step S9), and then updates the three-dimensional modeling data in order to delete the calculated cutting regions from the workpiece W, as well as redefines the three interference-risk regions A, B, C for the workpiece three-dimensional model (Step S10), and sends to the screen display processor 19 the updated three-dimensional modeling data (Step S11), and proceeds to Step S20.

On the other hand, when determining in Step S7 that the contacting or overlapping does not occur between items establishing the cutting relationship (it does not occur between the tip Tb of the tool T and the workpiece W), the movement-status recognition processor 18 defines that interference occurs between the main spindle 32, chuck 33 and workpiece W, and the first saddle 34, second saddle 35, tool rest 36 and tool T. Additionally, when determining in Step S8 that the command speed exceeds the maximum cutting feed rate, the movement-status recognition processor 18 does not regard the contacting or overlapping as machining of the workpiece W with the tool T, but define that interference occurs, and sends the alarm signal to the drive control unit 13 (Step S12) to end the series of the processes.

Moreover, in Step S12, the movement-status recognition processor 18 sends the generated three-dimensional modeling data to the screen display processor 19, and when the tool T interfere with the workpiece W and chuck 33, recognizes an interference point at where the tool T interferes with the workpiece W and chuck 33, and sends the recognized interference point to the screen display processor 19. It is because only the chuck 33, workpiece W, tool T and part of the tool spindle 36b are displayed on the screen display device 43 why the sending of the interference point is limited to when the tool T interferes with the workpiece W and chuck 33.

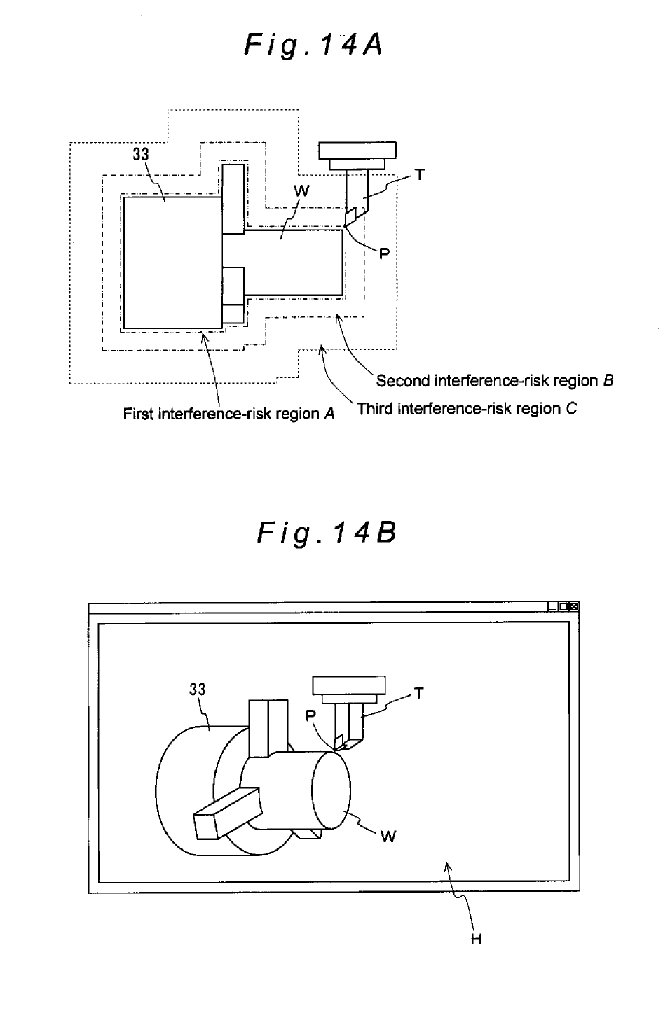

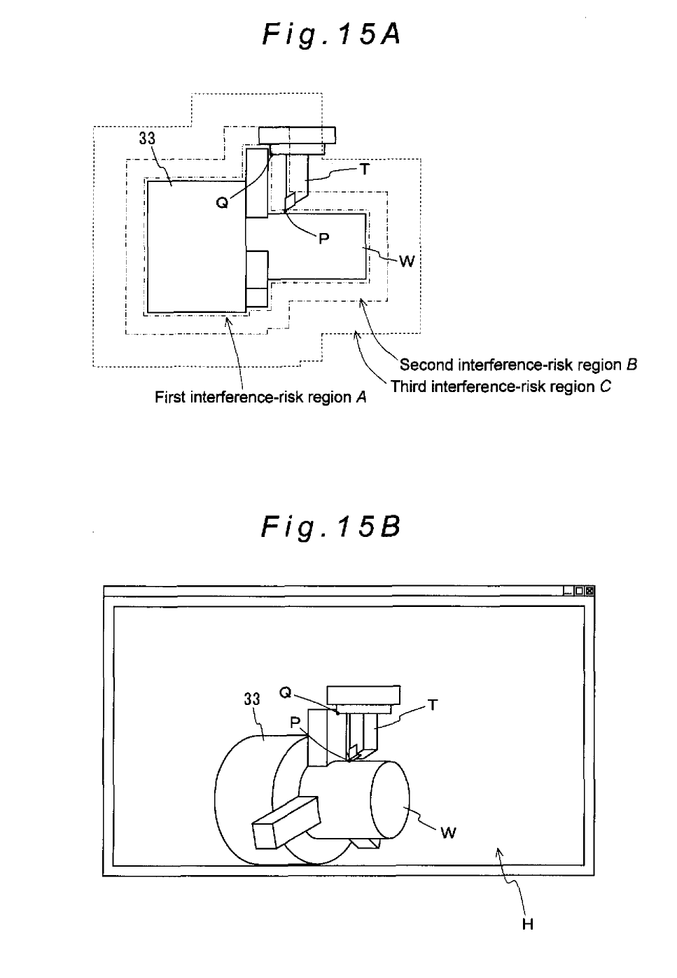

When it is determined in Step S6 that there is no contacting or overlapping portion (no interference occurs), the movement-status recognition processor 18 sends the generated three-dimensional modeling data to the screen display processor 19 (Step S13), and then checks, based on the generated three-dimensional modeling data, whether or not the three-dimensional modeling data for the tool T and tool spindle 36b enters (is present in) the first interference-risk region A (Step S14). For example, when the three-dimensional modeling data is determined to enter the region A, as illustrated in FIG. 14A and FIG. 15A, the movement-status recognition processor 18 recognizes intrusion locations P, Q at which the three-dimensional modeling data for the tool T and tool spindle 36b enters the first interference-risk region A to send to the screen display processor 19 a first intrusion-determination signal showing that the three-dimensional modeling data enters the first interference-risk region A, and the intrusion locations P, Q (Step S15), proceeding to Step S20. It should be understood that FIG. 14A illustrates the situation in which there is one entrance-occurring part, and FIG. 15A illustrates the situation in which there are a plurality of entrance-occurring parts.

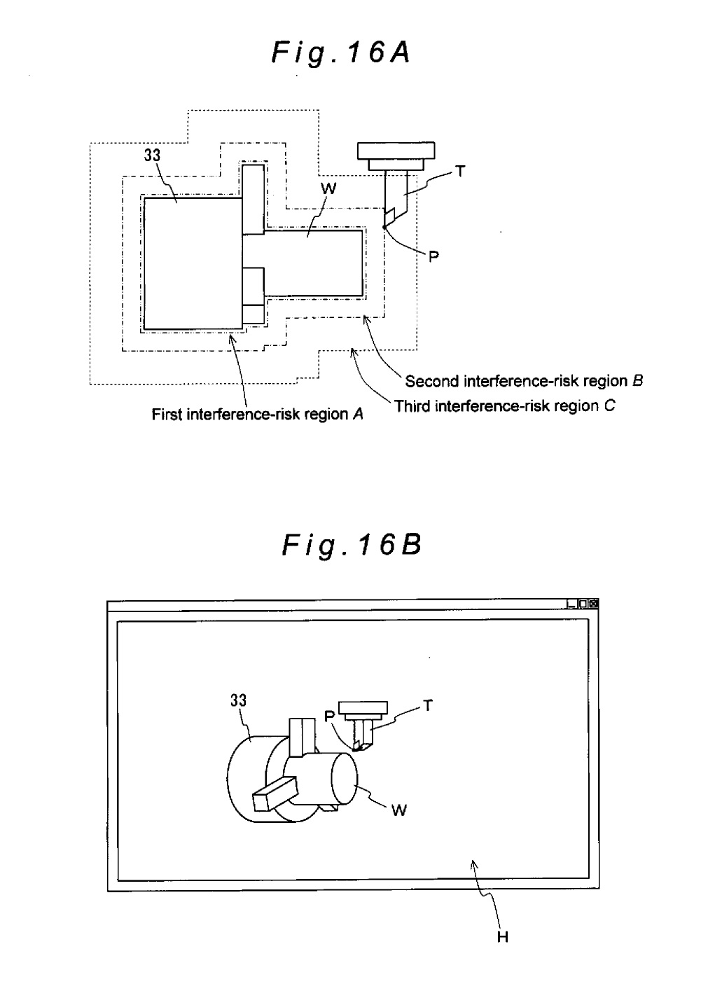

When the three-dimensional modeling data is determined in Step S14 not to enter the first interference-risk region A, the movement-status recognition processor 18 checks whether or not the three-dimensional modeling data for the tool T and tool spindle 36b enters (is present in) the second interference-risk region B (Step S16). For example, when the three-dimensional modeling data is determined to enter the second interference-risk region B as illustrated in FIG. 16A, the movement-status recognition processor 18 recognizes an intrusion location P at which the three-dimensional modeling data for the tool T and tool spindle 36b enters the second interference-risk region B to send to the screen display processor 19 a second intrusion-determination signal showing that the three-dimensional modeling data enters the second interference-risk region B, and the recognized intrusion location P (Step S17), proceeding to Step S20. It should be understood that as described above, when there are a plurality of entrance-occurring parts, their intrusion locations are recognized, and sent to the screen display processor 19.

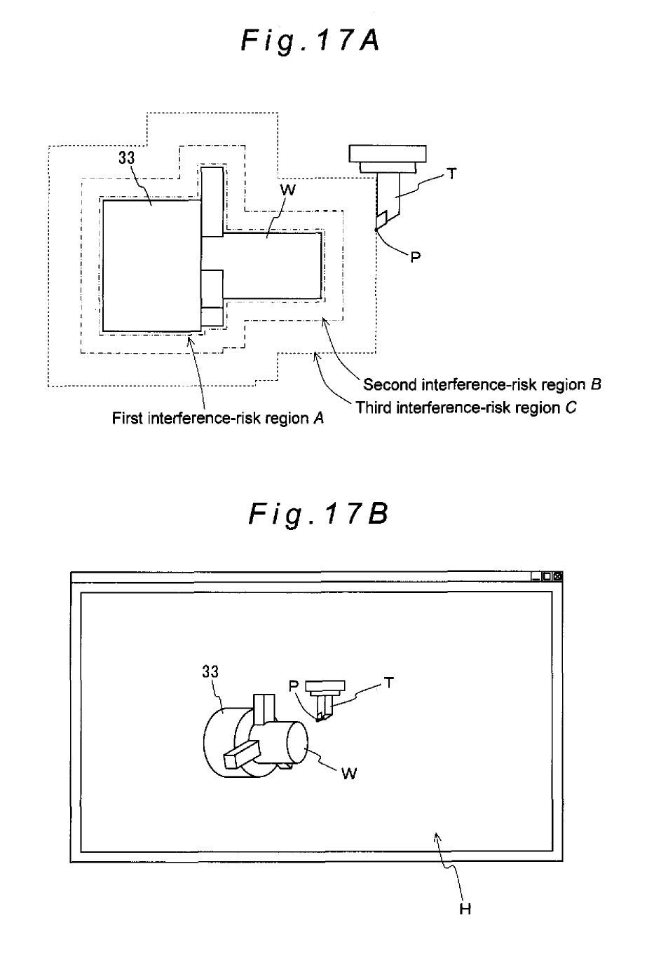

When the three-dimensional modeling data is determined in Step S16 not to enter the second interference-risk region B, the movement-status recognition processor 18 checks whether or not the three-dimensional modeling data for the tool T and tool spindle 36b enters (is present in) the third interference-risk region C (Step S18). For example, when the three-dimensional modeling data is determined to enter the third interference-risk region C as illustrated in FIG. 17A, the movement-status recognition processor 18 recognizes an intrusion location P at which the three-dimensional modeling data for the tool T and tool spindle 36b enters the third interference-risk region C to send to the screen display processor 19 a third intrusion-determination signal showing that the three-dimensional modeling data enters the third interference-risk region C, and the recognized intrusion location P (Step S19), proceeding to Step S20. On the other hand, the three-dimensional modeling data is determined in Step S18 not to enter the third interference-risk region C, the movement-status recognition processor 18 proceeds to Step S20. It should be understood that when there are a plurality of entrance-occurring parts, they are recognized, and sent to the screen display processor 19.

In Step S20, it is determined whether or not the processes are completed, and when the processes are not completed, the Step S4 or later steps are repeated. When the processes are determined to be over, the movement-status recognition processor 18 ends the series of processes.

The screen display processor 19 receives successively from the movement-status recognition processor 18 three-dimensional modeling data generated by the movement-status recognition processor 18, and describing the situation in which the first saddle 34, second saddle 35, tool rest 36 and tool T have been moved into the predicted move-to point, and generates, based on the received modeling data, three-dimensional image data in accordance with the modeling data to display the generated image data onscreen on the screen displaying device 43.

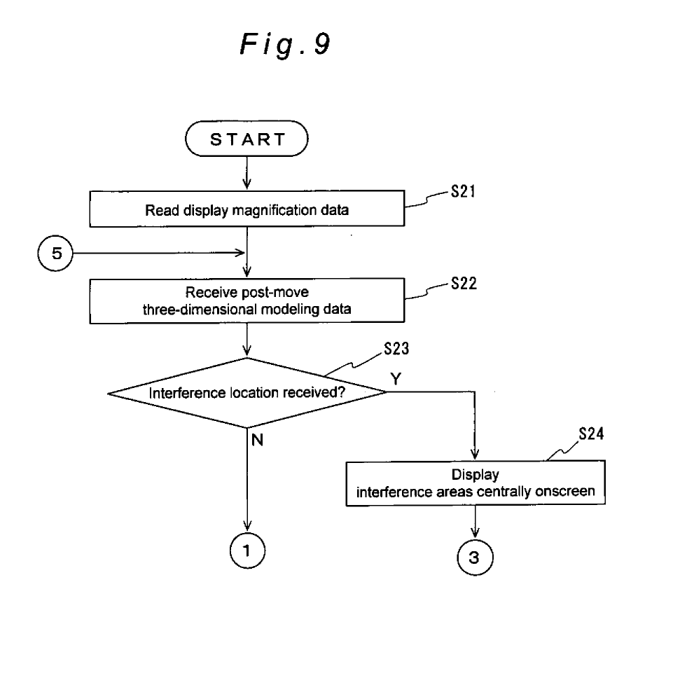

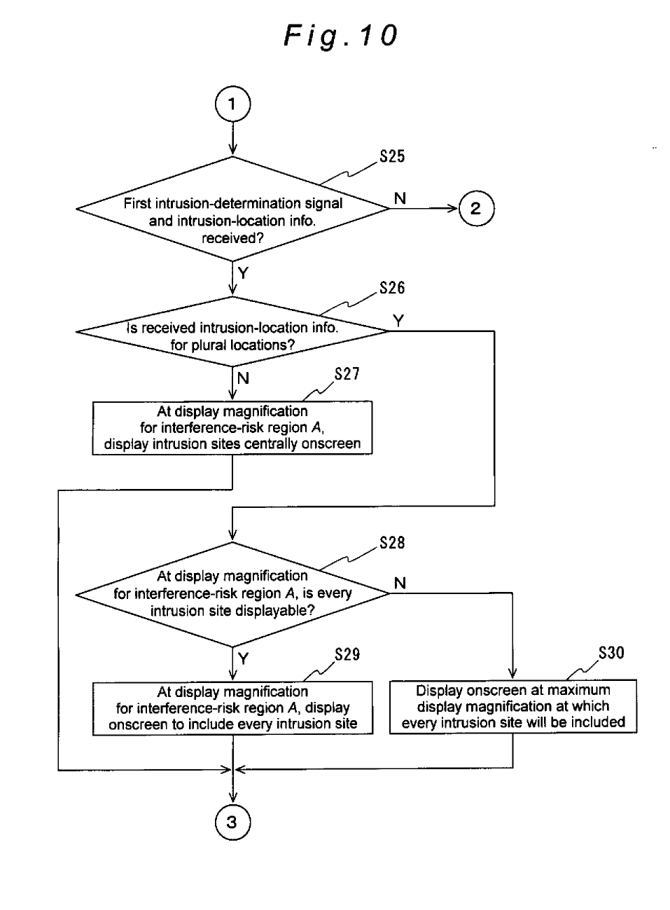

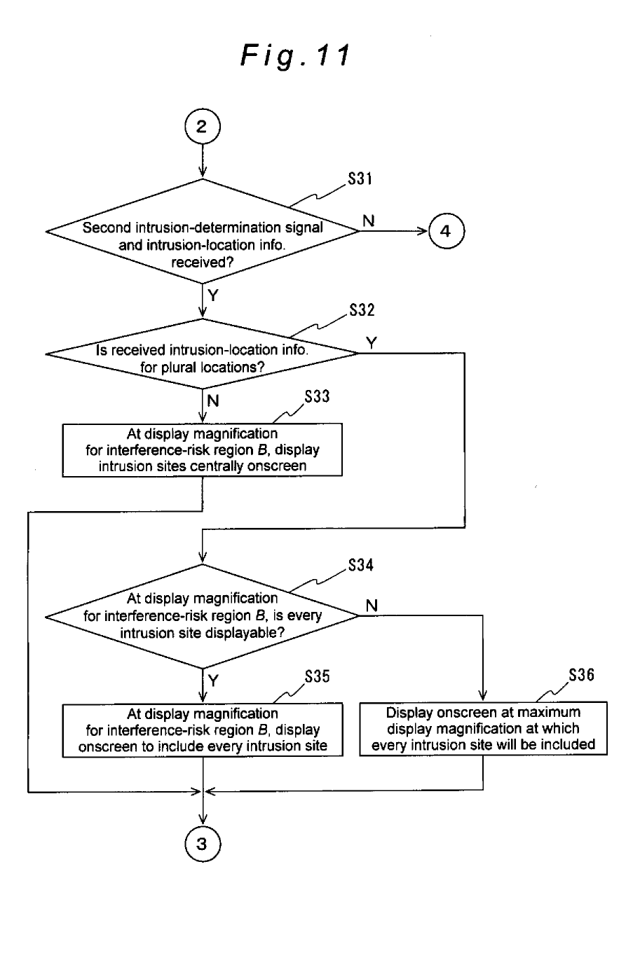

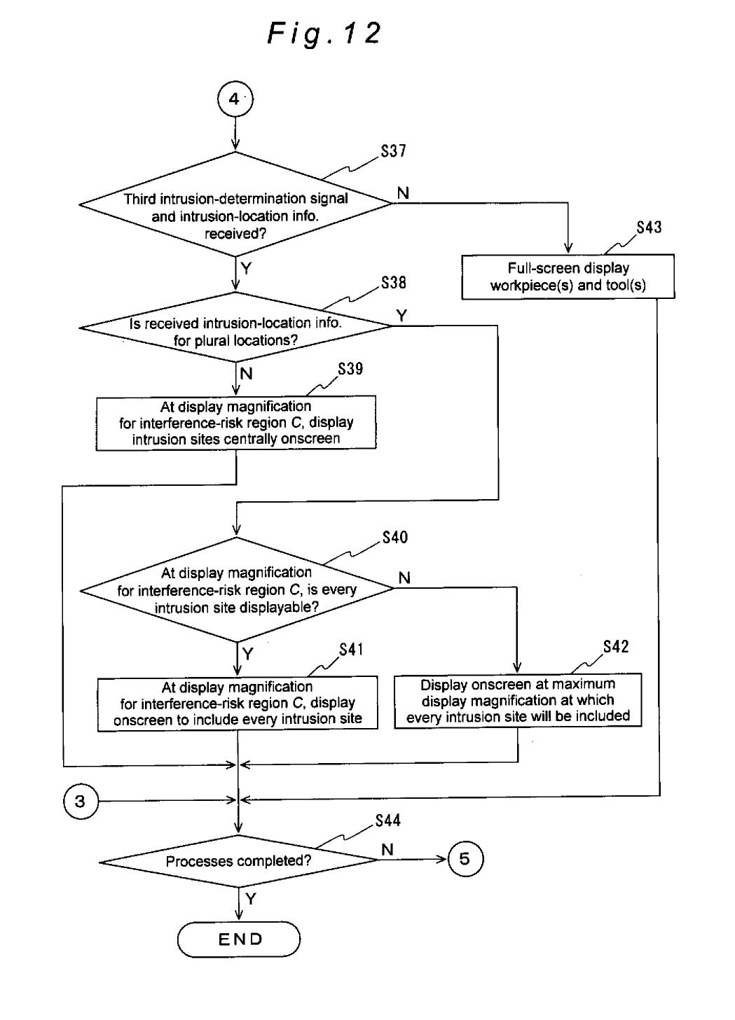

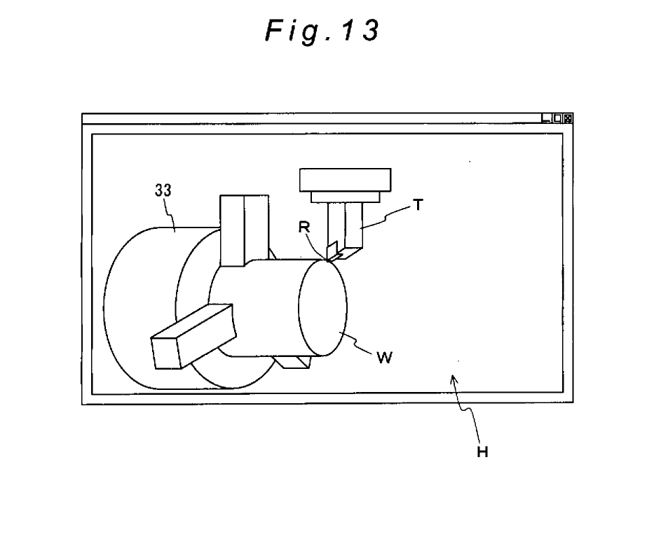

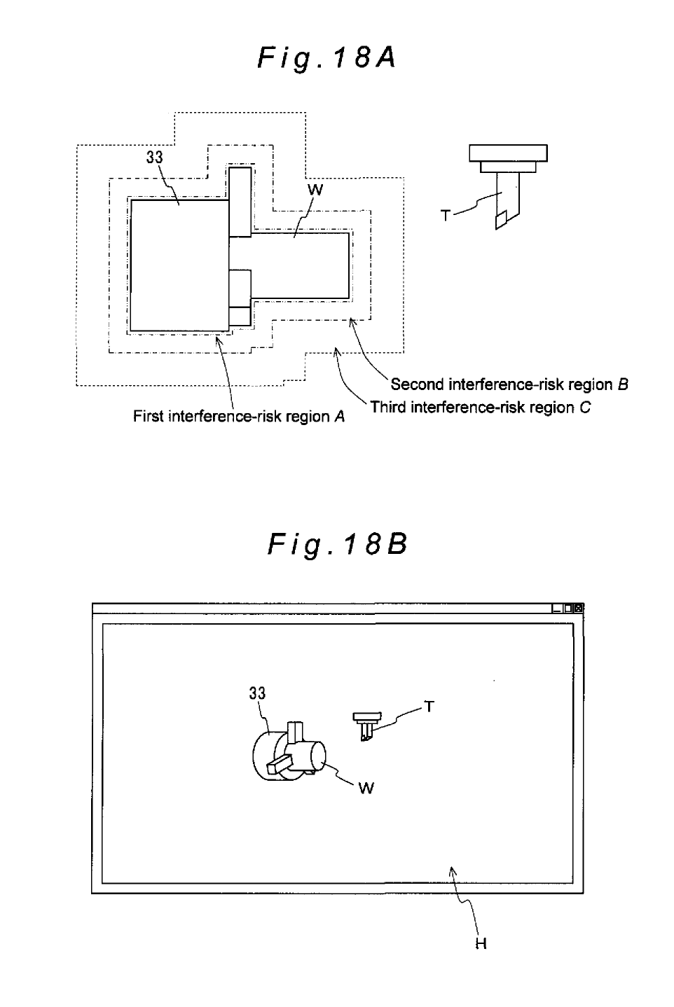

Specifically, the screen display processor 19 carries out a series of processes as represented in FIG. 9 through FIG. 12. For example, when the tool T interferes with the workpiece W and chuck 33, the screen display processor 19 generates the image data as illustrated in FIG. 13 to allow the screen display device 43 to display it. Additionally, for example, when the tool T and tool spindle 36b intrude into the interference-risk regions A, B, C, the screen display processor 19 generates the image data as illustrated in FIG. 14 through FIG. 17 to allow the screen display device 43 to display it, and when the tool T and tool spindle 36b do not enter any interference-risk regions A, B, C, generates the image data as illustrated in FIG. 18 to allow the screen display device 43 to display it.

As represented in FIG. 9 through FIG. 12, first, the screen display processor 19 reads the display magnifications stored in the display magnification data storage 17 (Step S21), and receives modeling data generated by, and sent from, the movement-status recognition processor 18 (Step S22).

After that, the screen display processor 19 checks whether or not the interference point is received form the movement-status recognition processor 18 (Step S23), and when it is not received, proceeds to Step S25. When the interference point is received, the screen display processor 19 generates, based on the received interference point, the image data to allow the screen display device 43 to display it so that, for example, an interference point R at where the tool T interferes with the workpiece W and chuck 33 coincides with the center point of the onscreen display area H of the screen display device 43, as illustrate in FIG. 13 (Step S24), proceeding to Step S44. It should be understood that in generating the image data so as to be onscreen, the screen display processor 19 displays it at a display magnification larger that that applied when the tool T and tool spindle 36b enter the first interference-risk region A (that is, a display magnification larger than the maximum display magnification stored in the display magnification data storage 17), and blinks the displayed image as an alarm display.

In step S25, the screen display processor 19 checks whether or not the first intrusion-determination signal and intrusion location have been received from the movement-status recognition processor 18, and when they have been received, checks whether or not a plurality of intrusion locations has been received (Step S26). When the plurality of the intrusion locations has not been received (that is, there is one entrance-occurring part), the screen display processor 19 generates, based on the received intrusion location P, and on the read display magnification defined for the first interference-risk region A, the image data to allow the screen display device 43 to display it so as to, as illustrate in FIG. 14A, appear at this display magnification with the received intrusion location P coinciding with the center point of the onscreen display area H of the screen display device 43 (Step S27), proceeding to Step S44.

On the other hand, when a plurality of intrusion locations has been received in Step S26 (that is, there are a plurality of entrance-occurring parts), the screen display processor 19 checks, from the received intrusion locations, and from the read display magnification defined for the first interference-risk region A, whether or not the intrusion locations can be displayed at this display magnification (Step S28).

Subsequently, when it is determined that the intrusion locations can be displayed, the screen display processor 19 generates the image data to allow the screen display device 43 to display the image data so as to, as illustrated in FIG. 15B, include the intrusion points P, Q, and so as to appear at the display magnification defined for the first interference-risk region A (Step S29), proceeding to Step S44. When it is determined that the intrusion locations cannot be displayed, the screen display processor 19 generates the image data to allow the screen display device 43 to display the image data so as to include the intrusion locations P, Q, and so as to appear at a maximum display magnification enabling display of the intrusion locations P, Q (Step S30), proceeding to Step S44.

It should be understood that in generating and displaying the image data in Step S29 and Step S30, generating the image data to display it so that the center points and gravity center points of a line segment or regions formed by joining a plurality of intrusion locations coincide with the center point of the onscreen display area H of the screen display device 43 enables effective display of the intrusion locations. The same goes for the Steps S35, S36, S41 and S42 that will be described hereinafter.

When it is determined in Step S25 that the first intrusion-determination signal and intrusion location have not been received, the screen display processor 19 checks whether or not the second intrusion-determination signal and intrusion location have been received from the movement-status recognition processor 18 (step S31). When they have been received, the screen display processor 19 checks whether or not a plurality of intrusion locations have been received (Step S32), when they have not been received (that is, there is one entrance-occurring part), generates, based on the received intrusion location P, and on the read display magnification defined for the second interference-risk region B, the image data to allow the screen display device 43 to display the image data so as to appear at this display magnification with the received intrusion location P coinciding with the center point of the onscreen display regions H of the screen display device 43 (Step S33), as illustrate in FIG. 16B, proceeding to Step S44.

On the other hand, when the plurality of the intrusion locations has been received in Step S32 (that is, there are a plurality of entrance-occurring parts), the screen display processor 19 checks, from the received intrusion locations, and from the read display magnification defined for the second interference-risk region B, whether or not the intrusion locations can be displayed at this display magnification (Step S34).

Then, when the intrusion locations are determined to be displayed, the screen display processor 19 generates the image data to allow the screen display device 43 to display it so as to include the intrusion locations, and so as to appear at the display magnification defined for the second interference-risk region B (Step S35), proceeding to Step S44. When it is determined that the intrusion locations cannot be displayed, the screen display processor 19 generates the image data to allow the screen display device 43 to display it so as to include the intrusion locations, and so as to appear at the maximum display magnification that enables their display (Step S36), proceeding to Step S44.

When it is determine in Step S31 that the second intrusion-determination signal and intrusion location have not been received, the screen display processor 19 checks whether or not the third intrusion-determination signal and intrusion location are received from the movement-status recognition processor 18 (Step S37). When they have been received, the screen display processor 19 checks whether or not a plurality of intrusion locations has been received (Step S38), and when they have not been received (that is, there is one entrance-occurring part), for example, as illustrate in FIG. 17B, generates, based on the received intrusion location P, and on the read display magnification defined for the third interference-risk regions C, image data to allow the screen display device 43 to display it so as to appear at this display magnification, with the received intrusion location P coinciding with the center point of the onscreen display area H of the screen display device 43 (Step S39), proceeding to Step S44.

On the other hand, when a plurality of intrusion locations has been received in Step S38 (that is, there are a plurality of entrance-occurring parts), the screen display processor 19 checks, form the received intrusion locations, and from the read display magnification defined for the third interference-risk region C, whether or not the intrusion locations can be displayed at this display magnification (Step S40).

Subsequently, it is determined that the intrusion locations can be displayed, the screen display processor 19 generates the image data to allow the screen display device 43 to display it so as to include the intrusion locations, and so as to appear at the display factor defined for the third interference-risk region C (step S41), proceeding to Step S44, and when it is determined that they cannot be displayed, generates the image data to allow the screen display device 43 to display it so as to include the intrusion locations, and so as to appear at the maximum display magnification that enables their display (Step S42), proceeding to Step S44.

When it is determined in Step S37 that the third intrusion-determination signal and intrusion location have not been received—that is, for example, as illustrated in FIG. 18A, the three-dimensional modeling data for the tool T and tool spindle 36b is present outside the interference-risk regions A, B, C, the screen display processor 19 proceeds to Step S43, in which as illustrates in FIG. 18B, the screen display processor 19 generates the image data involving an entire image including the chuck 33, workpiece W, tool T and a part of the tool spindle 36b to display the image data on the screen display device 43, proceeding to Step S44. It should be understood that this entire image, as illustrated in FIG. 18B, is displayed at a smaller display magnification, compared with FIGS. 14B, 15B, 16B, and 17B.

In Step S44, it is determined whether or not the processes are completed, and when the processes are not completed, the Step S22 or later steps are repeated. When the processes are determined to be completed, the screen display processor 19 ends the series of processes.

According to the controller 1 configured as above, of this embodiment, the three-dimensional modeling data involving at least the tool T, workpiece W, main spindle 32, chuck 33, first saddle 34, second saddle 35, and tool rest 36 is stored previously in the modeling data storage 15, and interference data defining interference relationships among the tool T, workpiece W, main spindle 32, chuck 33, first saddle 34, second saddle 35, and tool rest 36 is stored previously in the interference data storage 16. The image data display magnifications defined for the interference-risk regions A, B, C are stored previously in the display magnification data storage 17.

The feed mechanisms 37, 38, 39 are controlled by the drive control unit 13, based on the operational commands issued by means of the NC program and manual operation, and as a result, the movement of the tool rest 36 is controlled. At this time, the move-to points for the first saddle 34, second saddle 35, and tool rest 36 are predicted by the move-to point predicting unit 14, and based on the predicted move-to points, and on the data stored in the modeling data storage 15, the three-dimensional modeling data describing the situation in which the first saddle 34, second saddle 35, tool rest 36 and tool T have been moved into the predicted move-to points is generated by the movement-status recognition processor 18. Based on the generated modeling data, command speed, data stored in the interference data storage 16, whether or not the tool T and tool spindle 36b intrude into the interference-risk regions A, B, C, and whether or not the tool T, workpiece W, main spindle 32, chuck 33, first saddle 34, second saddle 35, and tool rest 36 interfere with each other are checked, and based on the three-dimensional modeling data generated by the movement-status recognition processor 18, and on the data stored in the display magnification data storage 17, the image data is generates, and displayed on the screen display device 43, by the screen display processor 19.

Subsequently, when the tool T and tool spindle 36b are determined to intrude into the interference-risk regions A, B, C, the intrusion-determination signal and intrusion location are sent from the movement-status recognition processor 18 to the screen display processor 19. Receiving them, the screen display processor 19 generates, when there is one entrance-occurring part, the image data to display it on the screen display device 43 so as to appear at the display magnification corresponding to the interference-risk regions A, B, C, with intrusion location coinciding with the center point of the onscreen display area of the screen display device 43, and generates, when there are a plurality of entrance-occurring parts, the image data to display it on the screen display device 43 so as to include the intrusion locations, and so as to appear at a display magnification corresponding to the interference-risk regions A, B, C, or so as to include the intrusion locations, and so as to appear at the maximum display magnification that enable display of the intrusion locations.

For this reason, in the situation in which the tool T and tool spindle 36b approach toward the workpiece W and chuck 33, and intrude into the interference-risk regions A, B, C for the workpiece W and chuck 33, the entrance-occurring part can be enlarged at a predetermined display magnification, and be displayed on the center part of the display screen of the screen display device 43 when there is one entrance-occurring part. When there are a plurality of entrance-occurring parts, the image data is enlarged and displayed on the screen display device 43 at the predetermined display magnification, or at the maximum display magnification enabling display of all the entrance-occurring parts.

Furthermore, when interference occurrence is determined, an alarm signal is sent from the movement-status recognition processor 18 to the drive control unit 13, which stops the feed mechanisms 37, 38, 39. Moreover, when the tool T will interfere with the workpiece W and chuck 33, their interference point is sent from the movement-status recognition processor 18 to the screen display processor 19, which generates, when receiving the interference point, the image data to display it in the screen display device 43 so as to appear at a display magnification larger than that applied when the tool T and tool spindle 36b intrude into the first interference-risk region A, with the interference point coinciding with the center point of the onscreen display area of the screen display device 43, and blinks the displayed image.

As just described, according to the controller 1 of this embodiment, a part at where approach of the tool T and tool spindle 36b toward the work W and chuck 33 increases the chance of the interference occurrence is enlarged and displayed onscreen, so that operators can grasp smoothly through the display screen of the screen display device 43 the positional relationship between the tool T and the workpiece W, and the movement of the tool T because the controller 1 is configured so that when the tool T and tool spindle 36 intrude into the interference-risk regions A, B, C, the entrance-occurring part is enlarged at a predetermined display magnification, and is displayed on the center part of the display screen of the screen display device 43, or is enlarged at the predetermined display magnification or at the maximum display magnification that enables display of the entrance-occurring parts, and is displayed onscreen, with the three interference-risk regions being defined around the chuck 33 and workpiece W, and with the display magnification in the situation in which the tool T and tool spindle 36b enter the three interference-risk regions A, B, C being defined so as to be larger than that in the situation in which the tool T and tool spindle 36b do not enter.

Furthermore, because the display magnification is defined so that the display magnifications inside the interference-risk regions A, B, C are larger than those outside the regions A, B, C, the smaller the distance between the tool T and the workpiece W and chuck 33, the larger the displayed interference-occurring part, which enables the operators to grasp quickly where is a part having a higher chance that interference may occur.

Moreover, the controller 1 is configured so that the screen display processor 19 checks the number of the parts in which the tool T and tool spindle 36b intrude into the interference-risk regions A, B, C, and when there is one entrance-occurring part, enlarges the part at the predetermined display magnification and displays it on the center part of the display screen, and when there are a plurality of the entrance-occurring parts, enlarges them at the predetermined display magnification, or at the maximum scale enabling display of all of the entrance-occurring parts, and displays them. Therefore, the workpiece W, chuck 33, tool T and a part of the tool spindle 36b can be effectively displayed onscreen even if there are a plurality of the entrance-occurring parts, not only one part.

Additionally, the configuration in which the screen display processor 19 receives the interference point recognized and sent when the movement-status recognition processor 18 checks interference, and at where the tool T interferes with the workpiece W and chuck 33, and then based on the received interference point, the interference point between the tool T and the workpiece W and chuck 33 is enlarged at a display magnification larger than the maximum display magnification stored in the display magnification data storage 17, and is displayed on the center part of the screen display of the screen display device 43 enables easier identification of the interference parts, improving the efficiency of the operators' work.

Moreover, the controller 1 is configured so that the modeling data describing the situation in which the first saddle 34, second saddle 35, tool rest 36 and tool T have been moved is generated, based on the move-to points, predicted by the move-to point predicting unit 14, and into which the first saddle 34, second saddle 35, and tool rest 36 are moved after a predetermined period of time, and whether or not interference will occur among the tool T, main spindle 32, chuck 33, first saddle 34, second saddle 35, and tool rest 36 and whether or not the tool T and tool spindle 36b intrude into the interference-risk regions A, B, C are checked, and image data is generated so as to be onscreen, based on the generated modeling data. In such a configuration, before the first saddle 34, second saddle 35, and tool rest 36 are actually moved as a result of driving of the feed mechanisms 37, 38, 39, under the control of the drive control unit 13, a chance of interference occurrence can be checked previously, and positional relationship between the tool T and the workpiece W, movement of the tool T can be checked. Therefore, in performing various operations, interference occurrence is advantageously prevented.

The above is a description of one embodiment of the present invention, but the specific mode of implementation of the present invention is in no way limited thereto.

The embodiment above presented the NC lathe 30 as one example of the machine tool, but the controller 1 according to this embodiment can be set up also in a machining center and various other types of machine tools. For example, in a lathe provided with a plurality of tool rests, advantageously, when the tool rests intrude into the interference-risk regions for the workpiece, it is determined that there are a plurality of entrance-occurring parts, and the image data is generated and displayed onscreen so that the entrance-occurring parts in the tool rests are included, and are displayed at a predetermined display magnification or at the maximum display magnification that enables display of each of the entrance-occurring parts in the tool rests.

Moreover, the three-dimensional modeling data stored in the modeling data storage 15 may be generated by any means, but in order to perform with a high degree of accuracy image data generation, determination of entrance to the interference-risk regions, and interference checking, it is preferable to use data that is generated accurately rather than data that is generated simply. And two-dimensional model, as an alternative to the three-dimensional model, may be stored in the modeling data storage 15.

In the example described above, the controller 1 is configured so that the movement-status recognition processor 18 employs the move-to points, predicted by the move-to point predicting unit 14, of the first saddle 34, second saddle 35 and tool rest 36, to generate the three-dimensional modeling data describing the situation in which they have been moved, but there is no limitation on the configuration, so the controller 1 may be configured so that the move-to point predicting unit 14 is omitted and the current points of the first saddle 34, second saddle 35, and tool rest 36 are received from the drive control unit 13, and based on the current points, the three-dimensional modeling data describing the situation in which they have been moved is generated.

Additionally, in above example, as illustrated in FIG. 13 through FIG. 18, the controller 1 is configured so that the chuck 33, workpiece W, tool T, and part of the tool spindle 36b are displayed onscreen, but this configuration is one example, display mode is not limited to it. For example, acceptable is a configuration in which the tool rest 36 is entirely displayed, and the first saddle 34, second saddle 35, main spindle 32, and (not-illustrated) headstock are also displayed.

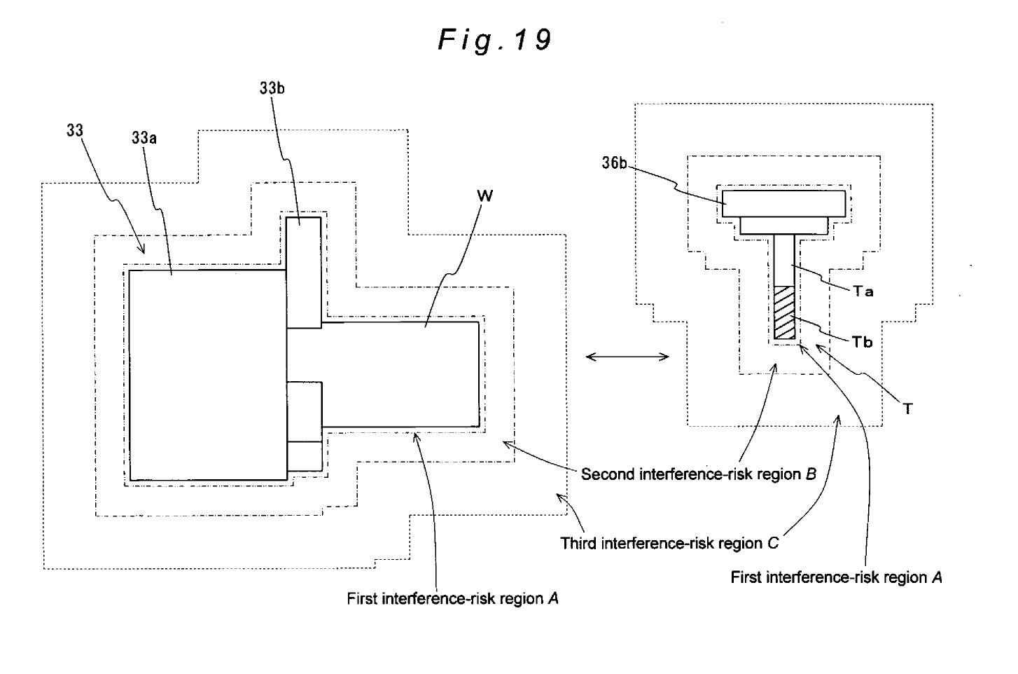

Furthermore, in above example, although the interference-risk regions A, B, C are defined around the chuck 33 and workpiece W, they may be defined both around the chuck 33 and workpiece W and around a part of the tool spindle 36b and tool T, as illustrated in FIG. 19. And the interference-risk regions A, B, C may be defined only around the tool spindle 36b and tool T, which is not illustrated particularly. Moreover, the number of the interference-risk regions to be defined is not limited to three. It should be understood that the tool T may be drill, end mill and other rotating tools, not cutting tool and other turning tools. The code Ta indicates a tool body, and the code Tb indicates a blade.

Also in this configuration, the part in which the approach of the tool T and tool spindle 36b toward the workpiece W and chuck 33 increases the chance of interference occurrence is enlarged and displayed onscreen by checking whether or not the three-dimensional model for the tool spindle 36b and tool T enters the interference-risk regions A, B, C around the chuck 33 and workpiece W, and whether or not the three-dimensional modeling data for the chuck 33 and workpiece W enters the interference-risk regions A, B, C around the tool spindle 36b and tool T.

Furthermore, although in above example, the controller 1 is configured so that when confirming at the tool T and tool spindle 36b do not enter any interference-risk regions A, B, C, the screen display processor 19 generates the image data, as illustrated in FIG. 13, including chuck 33, workpiece W, tool T and a part of the tool spindle 36b to display it on the screen display device 43, the display image displayed onscreen when the tool T and tool spindle 36b do not enter any interference-risk regions A, B, C is not limited to it.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A controller provided in a machine tool furnished with one or more moving bodies, with a feed mechanism for driving the one or more moving bodies to move them, with one or more structural elements arranged within the region in which the one or more moving bodies can move, and with a screen display means for displaying image data, the machine-tool controller comprising:
a control execution processing unit for controlling, based on an operational command for the one or more moving bodies, actuation of the feed mechanism to control at least move-to points for the one or more moving bodies;
a modeling data storage for storing modeling data relating to two-dimensional as well as three-dimensional models of, and including at least geometry data defining shapes of, the one or more moving bodies and one or more structural elements; and
a screen display processor for generating, and having the screen display means display onscreen, two-dimensional as well as three-dimensional image data of the one or more moving bodies and one or more structural elements;
a display magnification data storage for storing display magnifications, the display magnifications being of the image data, applied to situations where the one or more moving bodies and/or one or more structural elements intrudes into one or more interference-risk regions obtained by displacing outwards the geometry of the outer form of the one or moving bodies and/or one or more structural elements, and the display magnifications being defined for each of the one or more interference-risk regions in such a way that the magnification inward is larger than outward in the displacing direction for that interference-risk region; and
a movement-status recognition processor for executing
a process of defining the one or more interference-risk regions for the two-dimensional or three-dimensional models of the one or more moving bodies and/or the one or more structural elements, and receiving from said control execution processing unit the move-to points for the one or more moving bodies, to generate, based on the defined interference-risk regions, on the received move-to points, and on the modeling data stored in said modeling data storage, data modeling the situation in which the one or more moving bodies have been moved into move-to point,
a process of checking, based on the generated modeling data, whether the one or more moving bodies and/or the one or more structural element would intrude into an interference-risk region, and
a process of, when having determined that there would be intrusion into an interference-risk region, recognizing in which interference-risk region any intrusion would occur and any such intrusion's location, and transmitting to said screen display processor both an intrusion-determination signal indicating that there would be intrusion into the recognized interference-risk region, and information as to the recognized location of any such intrusion; wherein said screen display processor is configured to execute
based on the data, generated by said movement-status recognition processor, modeling the situation in which the one or more moving bodies has been moved into move-to point, a process of generating, and having the screen display means display onscreen, the image data in accordance with the modeling data, and
when having received an intrusion-determination signal and intrusion-location information from said movement-status recognition processor, a process of recognizing, based on the received intrusion-determination signal, the interference-risk region into which there would be intrusion, and recognizing the display magnification, stored in said display magnification data storage, that corresponds to the recognized interference-risk region, and, based on the recognized display magnification and on the received intrusion-location information, generating, and having the screen display means display onscreen, the image data in such a way that it is displayed at that display magnification, and in such a way that any intrusion location and the mid-position of an onscreen display area on said screen display means coincide.

2. A machine-tool controller as set forth in claim 1, wherein:
said movement-status recognition processor is configured to further execute, in addition to said processes, a process of checking, based on the generated modeling data, whether the one or more moving bodies and one or more structural elements would interfere with each other, and if having determined that they would interfere with each other, recognizing the location of the interference, and transmitting the recognized interference location to said screen display processor and transmitting an alarm signal to said control execution processing unit;
said screen display processor is configured to, when having received an interference location from said movement-status recognition processor, based on the received interference location generate, and have the screen display means display onscreen, the image data in such a way that it is displayed at a display magnification greater than the maximum display magnification stored in said display magnification data storage, and in such a way that the interference location and the mid-position of the onscreen display area on said screen display means coincide; and
said control execution processing unit is configured to halt movement of the one or more moving bodies when having received an alarm signal from said movement-status recognition processor.

3. A machine-tool controller as set forth in claim 1, further comprising a move-to point predicting unit for receiving from said control execution processing unit at least a current point of the one or more moving bodies, to predict from the received current point the move-to point or points to which the one or more moving bodies will have moved after elapse of a predetermined period of time; wherein
said movement-status recognition processor is configured to, in generating the data modeling the situation in which the one or more moving bodies have been moved, receive from said move-to point predicting unit the predicted move-to point or points for the one or more moving bodies, and generate, based on the received predicted move-to point or points and on the modeling data stored in said modeling data storage, data modeling the situation in which the one or more moving bodies has been moved into the predicted move-to point or points.

4. A machine-tool controller as set forth in claim 1, wherein said screen display processor is configured to:
when having received an intrusion-determination signal and intrusion-location information from said movement-status recognition processor, recognize, based on the received intrusion-determination signal, the interference-risk region into which there would be intrusion, and recognize the display magnification, stored in said display magnification data storage, that corresponds to the recognized interference-risk region, and determine, based on the intrusion-location information, the number of places where there would be an intrusion; and
if there is one place where it is determined there would be an intrusion, based on the recognized display magnification and on the received intrusion-location information, generate, and have the screen display means display onscreen, the image data in such a way that it is displayed at that display magnification, and in such a way that the intrusion location and the mid-position of the onscreen display area on said screen display means coincide, and
if there is a plurality of places where it is determined there would be an intrusion, based on the recognized display magnification and on the received intrusion-location information, verify whether all of the intrusion locations will appear if displayed at that display magnification, and where having determined that they will appear, generate, and have the screen display means display onscreen, the image data in such a way that it is displayed at that display magnification, and in such a way that the intrusion locations are included, and where having determined that they will not appear, generate, and have the screen display means display onscreen, the image data in such a way that it is displayed at the maximum display magnification at which display of all of the intrusion locations is possible, and in such a way that all of the intrusion locations are included.

5. A machine-tool controller as set forth in claim 4, wherein:
said movement-status recognition processor is configured to further execute, in addition to said processes, a process of checking, based on the generated modeling data, whether the one or more moving bodies and one or more structural elements would interfere with each other, and if having determined that they would interfere with each other, recognizing the location of the interference, and transmitting the recognized interference location to said screen display processor and transmitting an alarm signal to said control execution processing unit;
said screen display processor is configured to, when having received an interference location from said movement-status recognition processor, based on the received interference location generate, and have the screen display means display onscreen, the image data in such a way that it is displayed at a display magnification greater than the maximum display magnification stored in said display magnification data storage, and in such a way that the interference location and the mid-position of the onscreen display area on said screen display means coincide; and
said control execution processing unit is configured to halt movement of the one or more moving bodies when having received an alarm signal from said movement-status recognition processor.

6. A machine-tool controller as set forth in claim 4, further comprising a move-to point predicting unit for receiving from said control execution processing unit at least a current point of the one or more moving bodies, to predict from the received current point the move-to point or points to which the one or more moving bodies will have moved after elapse of a predetermined period of time; wherein
said movement-status recognition processor is configured to, in generating the data modeling the situation in which the one or more moving bodies have been moved, receive from said move-to point predicting unit the predicted move-to point or points for the one or more moving bodies, and generate, based on the received predicted move-to point or points and on the modeling data stored in said modeling data storage, data modeling the situation in which the one or more moving bodies has been moved into the predicted move-to point or points.

7. A machine-tool controller as set forth in claim 5, further comprising a move-to point predicting unit for receiving from said control execution processing unit at least a current point of the one or more moving bodies, to predict from the received current point the move-to point or points to which the one or more moving bodies will have moved after elapse of a predetermined period of time; wherein
said movement-status recognition processor is configured to, in generating the data modeling the situation in which the one or more moving bodies have been moved, receive from said move-to point predicting unit the predicted move-to point or points for the one or more moving bodies, and generate, based on the received predicted move-to point or points and on the modeling data stored in said modeling data storage, data modeling the situation in which the one or more moving bodies has been moved into the predicted move-to point or points.
